(19) United States
(12) Patent Application Publication
(10) Pub. No.: US 2012/0205360 A1
(43) Pub. Date: Aug. 16, 2012

(54) Computer Aided Beam Fabrication Machine

(75) Inventor: Kevin Francis Fitzpatrick, Sorrento (AU)

(73) Assignee: Smart Steel Systems PTY LTD, Loganholme (AU)

(21) Appl. No.: 13/503,893

(22) PCT Filed: Oct. 26, 2010
(86) PCT No.: PCT/AU10/01428

§ 371 Date: Apr. 25, 2012

(30) Foreign Application Priority Data
Oct. 27, 2009 (AU) 2009905234

(51) Int. Cl. B23K 37/04; B25B 1/24; B23P 23/00; B23Q 7/04; B23Q 3/00

(52) U.S. Cl. 219/137 R; 269/55; 269/56; 219/159; 29/407.04

(57) ABSTRACT

A beam working apparatus, includes opposed vice assemblies for holding and rotating a beam about a long axis thereof and a number of gantries that are arranged for translational motion along the beam. At least one tool head mount is provided fast with each of the gantries for a tool for working upon the beam. A number of motors are provided to selectively rotate the vice assemblies and move the gantries in order that the apparatus can be operated by a computerized control system.

### TECHNICAL FIELD

Particular embodiments of the present invention relate to CNC beam line machines that automatically cut and drill steel beams.

### BACKGROUND

The discussion of any prior art documents, techniques, methods or apparatus is not to be taken to constitute any admission or evidence that such prior art forms, or ever formed, part of the common general knowledge.

Steel fabrication is a labor intensive operation. During steel fabrication steel beams are drilled and cut according to shop drawings in order that they can be assembled to meet the relevant engineering requirements for the construction at hand. Typically only about a third of the cost of fabricated steel lies in the value of the un-worked steel. The remainder of the cost lies in the working hours.

Over the years various approaches have been taken to make steel fabrication less labour intensive. One such approach is the use of CNC beam line machines. Such machines generally include a table along one side of which a beam to be worked is positioned. A motorized tool mount is arranged to move along the side of the table and to rise and fall as required in order to perform various operations on the beam, for example drilling of holes.

Although the CNC beam lines of the prior art increase the throughput of a steel fabrication plant, nevertheless they suffer from a number of disadvantages. For example, the variety and range of operations that can be performed on the beam is undesirably limited.

It is an object of the present invention to provide an apparatus which is an improvement, or at least a useful alternative to those steel fabrication machines which are presently known.

### SUMMARY OF THE INVENTION

According to a first aspect of the invention there is provided a beam working apparatus, including:
a vise assembly for holding and rotating a beam about a long axis thereof;
at least one translation assembly for motion along the beam; and
at least one tool head mount fast with said translation assembly for a tool for working upon the beam.

Preferably the vise assembly includes a pair of opposed vises arranged to cooperatively hold and rotate the beam.

Preferably the apparatus includes at least one motor to draw the vises together and apart.

Preferably the vises include respective rotatable cradles to support the beam.

The apparatus may further include at least one motor to rotate the cradles.

In a preferred embodiment, the at least motor to draw the vises together and apart is coupled to a rack and pinion arrangement.

The vises may run on wheels and wherein the rack and pinion arrangement includes a first rail, fitted with the rack, and a pinion for meshing with the rack, said pinion being fast with a spindle of the at least motor, said motor coupled to one of said vises.

In a preferred embodiment the translation assembly comprises at least one gantry.

The apparatus may include a gantry motor to move the gantry relative to the pair of vises.

Said tool head mount preferably comprises one or more of a pan, tilt and roll motor.

Preferably the at least one gantry rides along at least a second rail.

The at least one gantry may ride along a first pair of rails and said vises ride along a second pair of rails. The first pair of rails is preferably located outside the second pair of rails.

In a preferred embodiment the at least one gantry comprises three gantries and the at least one tool head mount comprises three corresponding tool head mounts coupled thereto.

Preferably a welding tool is mounted to one of said tool head mounts.

Preferably a laser position detector is mounted to one of said tool head mounts.

Preferably a cutting tool is mounted to one of said tool head mounts.

An electromagnet may be mounted to one of said tool head mounts for selectively holding components to be welded to the beam.

The apparatus may include a holder at a predetermined position for storing the components.

For example, such components may comprise cleats to be welded to the beam with the welding tool.

The apparatus may include a computerized control system for said remote operation.

Preferably the computerized control system includes a computer arranged to read drawing files containing information for working of the steel beam.

The computerized control system may further include one or more controller boards arranged to interface between the computer and motors of one or more of the gantries, tool mount assemblies and vises in order to move a tool coupled to the tool mount assemblies to carry out the working of the steel beam.

Preferably the controllers are responsive to position encoders of said motors.

According to a further aspect of the present invention there is provided a method of working a beam comprising the steps of:
rotating the beam along its long axis through a desired angle for access by a tool head;
checking the position of the beam with a laser measuring device;
moving the tool head to a predetermined position adjacent the beam; and
operating the tool head upon the beam;
   wherein each step of said method is controlled by an electronic control system.

The method may include a step of relocating a component for attachment to the beam from a storage position to the predetermined position by gripping the component with an electromagnet.

The method may include checking the component for correct orientation with the laser measuring device.

The tool head may comprise a welding head. The component may comprise a cleat.

The method may include operating the electromagnet and the welding head in concert to weld the component to the beam.

Preferably the tool head is moved along the beam by a translation assembly to the predetermined position.

Alternatively, the tool head may include a cutting head for forming apertures in the beam.

In a further embodiment the tool head may include a spray painting head for applying paint to the beam.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective, and somewhat stylized view of a steel beam fabrication apparatus, loaded with a work piece, according to a preferred embodiment of the present invention.

FIG. 2 is a close up of a vise of the apparatus.

FIG. 3 is a further view of the vise of the apparatus.

FIG. 4 is a view of a motor for moving a sled of the vise.

FIG. 5 is an end view of a motor of the apparatus showing a rotary encoder assembly.

FIG. 6 is a view of an upper section of a gantry of the apparatus.

FIG. 7 is a view of a tool mount of the apparatus.

FIG. 8 is a block diagram of a control system of the apparatus.

FIG. 9 is a view of the interior of a control cabinet of the control system.

FIG. 10 is a view of the apparatus during a further stage of operation.

FIG. 11 is a view of apparatus during yet another stage of operation.

### DETAILED DESCRIPTION OF PREFERRED EMBODIMENTS

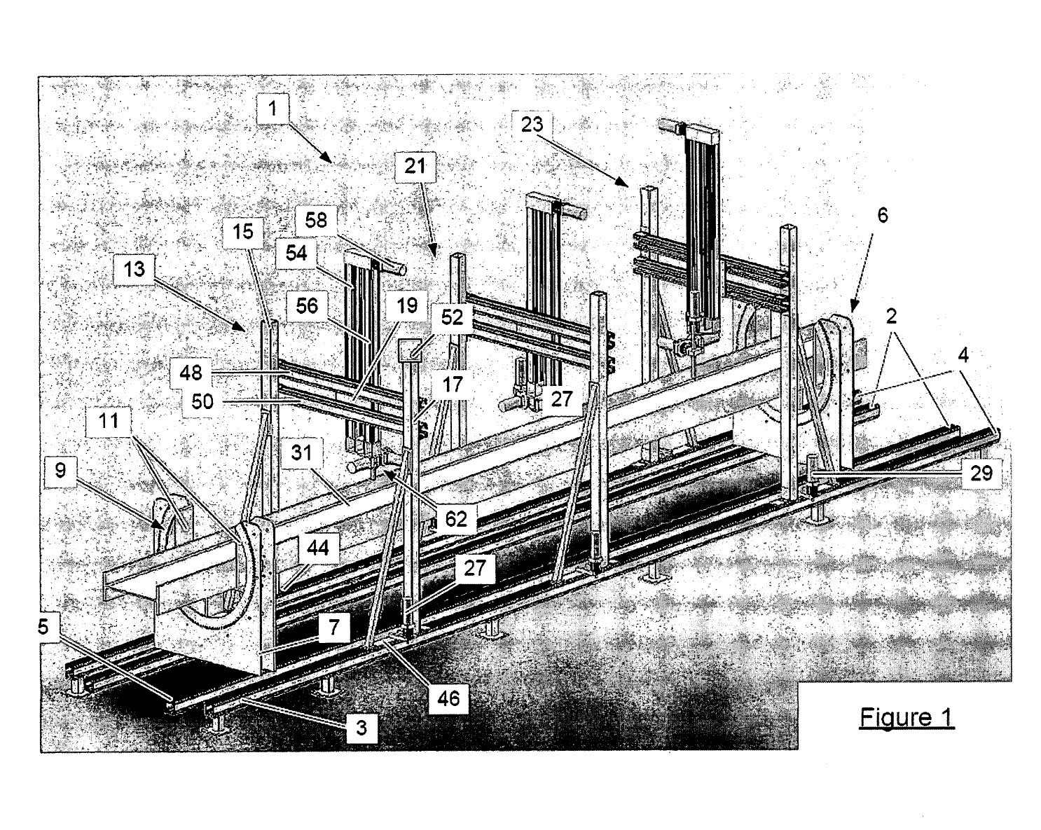

Referring now to FIG. 1, there is depicted a somewhat stylized view of a beam fabrication machine 1 according to a preferred embodiment of the present invention. The beam fabrication machine 1 is shown loaded with a work piece in the form of a steel beam 31.

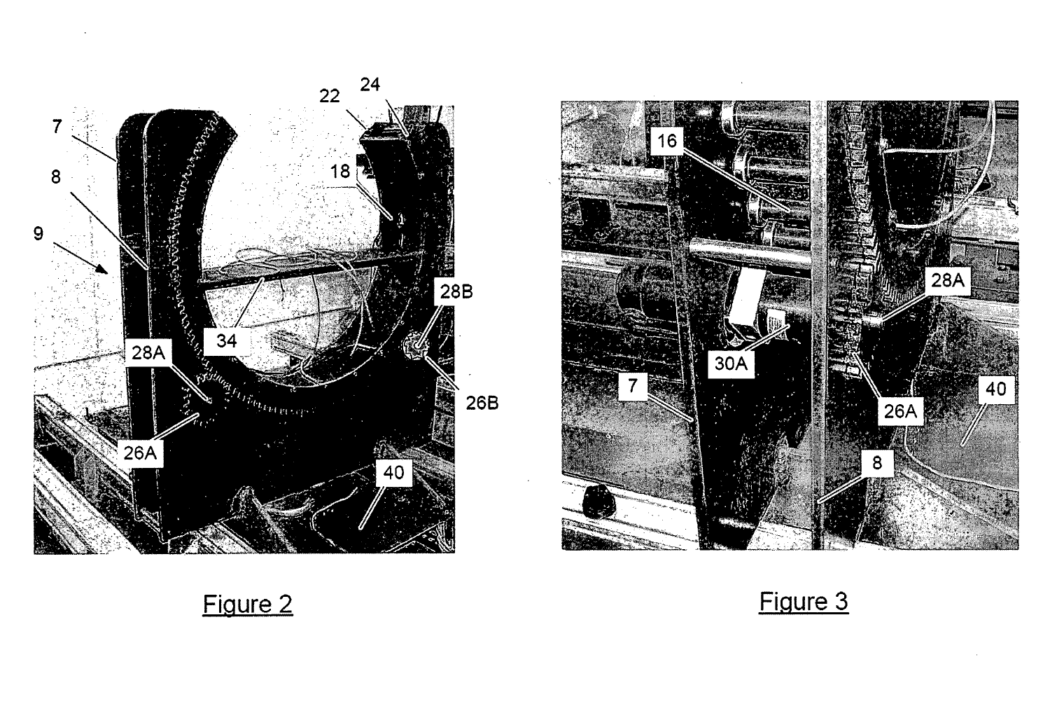

Fabrication machine 1 includes an inner pair of rails 2, and an outer pair of rails 4. Two rotatable vises, 9 and 6 ride along the inner pair of rails 2. FIGS. 2, 3 and 4 show vise 9 in greater detail.

The arrangement of vise 6 corresponds to that of vise 9 which will now be described with reference to FIGS. 2 and 3. The vise 9 is comprised of a stand in the form of an opposing pair of plates 7, 8 interconnected by bearing rollers 16 which are disposed in an arc about corresponding central arcuate cutouts formed through each plate. The bearing rollers support an arcuate cradle 18 that is located within the cutout and is flanged with opposing arcuate flanges 22 and 24 that overhang the outer sides of plates 7,8 about the edges of the respective cutouts. The periphery of flange 24 is toothed and meshes with teeth of step down cogs 26A, 26B. Each step down cog 26A, 26B is fitted to respective spindles 28A, 28B of servo motors 30A, 30B (not visible). The servo motor 30A is fitted with a positional encoder 44 (visible in FIG. 5) in order that a control system, which will be described shortly, is able to monitor the position of the spindle and hence the angle of cradle 18.

Fitted across the inside of the cradle is a support bench 34 upon which opposing slideable jaws 11 (visible in FIG. 1) are fitted. The slideable jaws 11 are arranged to cooperate to hold a work piece, which is usually an elongate metal member, such as steel beam 31.

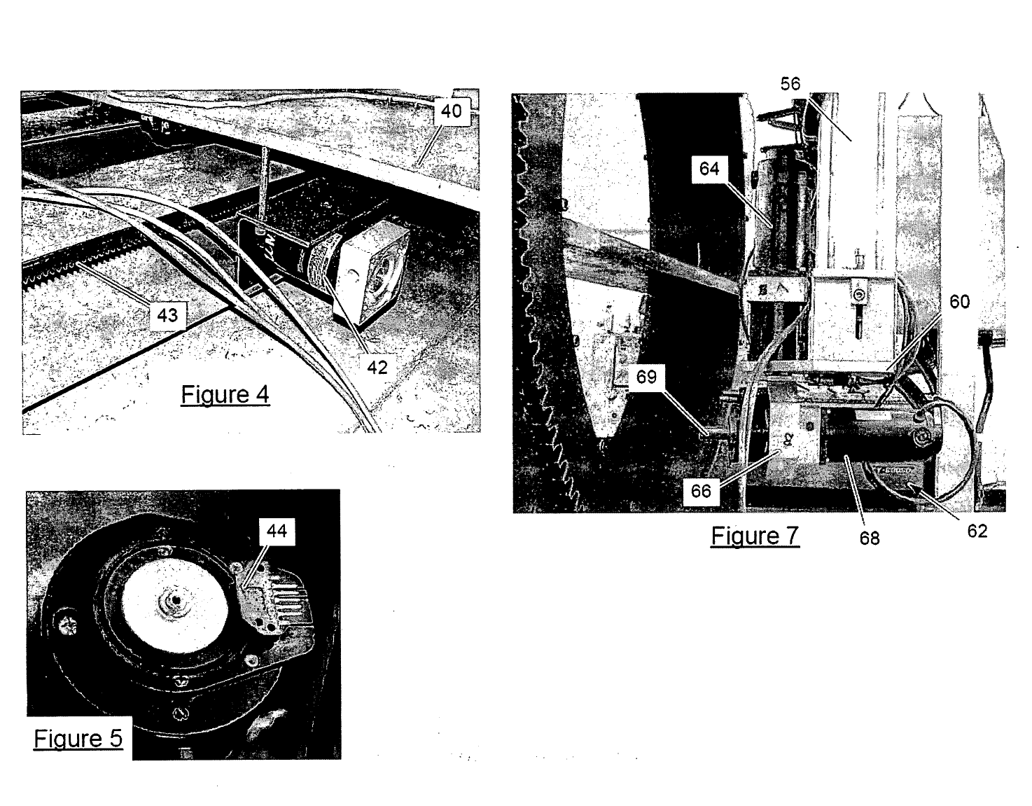

The vise 9 further includes a sled 40 which supports the opposed plates 7 and 8 of the stand and includes wheels (not shown) to roll between inner rails 2. With reference to FIG. 4, servo motors 42 are fitted on either side of the underside of sled 40. The servo motors 42 have spindles that are fitted with corresponding pinions (not shown) which mesh with respective racks 43 fastened along the inside of rail 2. Consequently, in use the servo motors 42 are able to precisely translate vise 9 along the inner rails 2. Furthermore, the position of the vise 9 can be determined by monitoring signals from a rotary encoder of the servo motors 42.

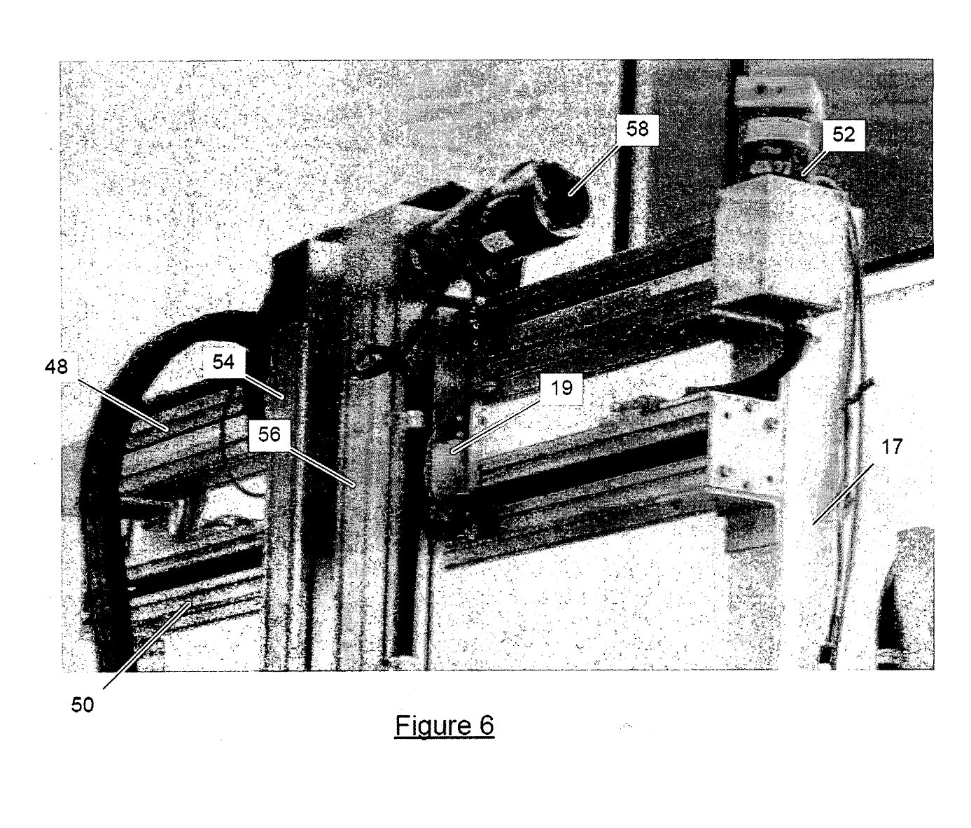

Referring again to FIG. 1, and also to FIG. 6, a translation assembly comprising three gantries, 13, 21 and 23, ride along outer rails 4. The gantries are of similar construction and will be described with reference to gantry 13. Gantry 13 is comprised of a pair of upright posts 15 and 17 which extend upward from respective bases 44, 46. The bases 44 and 46 are fitted with servo motors 27 that are coupled to the outer rails 4 by means of a rack and pinion arrangement similar to that previously explained with reference to vise 9. Accordingly, gantry 13 can be precisely moved, i.e. translated, along outer rails 4 by an electronic control system as will be described in due course.

Parallel cross rails 48 and 50 span the upper ends of posts 15 and 17. A carriage 19 is fitted across cross bars 48 and 50 and arranged to slide along them. A drive band is fitted within the upper cross rail between opposing sprockets and arranged for rotation by a servo motor 52 fitted atop of post 17. The drive band is coupled to carriage 19 so that by operating servo motor 52, carriage 19 may be accurately positioned along cross bars 48 and 50 as desired.

A pair of parallel, vertical rails 54 and 56 slidingly engage carriage 19. The vertical rails 54 and 56 may be raised and lowered relative to carriage 19 via operation of servo motor 58. The servo motor 58 is coupled to a drive band that is fitted within vertical rail 56 and which engages with carriage 19 in order to raise and lower rails 54 and 56 relative to the carriage.

A multiple axis tool mount assembly 62 is fitted at the lower end of rails 54 and 56 as shown in FIG. 7. The tool mount assembly 62 comprises a horizontal support plate 60 upon which a panning servo motor 64 is mounted. The spindle of panning servo motor 64 protrudes through an opening in support plate 60 and is attached to a vertical yoke 66 which supports a roll servo motor 68. Consequently a tool, for example a plasma cutter (not shown) fitted to the spindle of roll servo motor 68, can be moved about five axes of motion. Apart from a plasma cutter, other tools that may be interchangeably fitted to the tool mount include a welder, marker, spray paint head, electromagnet, laser position detector and a drill. The tool mount may be simultaneously fitted with more than one tool. For example two tools, faxing in opposing direction may be fitted in some circumstances so that each can be rotated into position for use when required.

The five axes of motion of the tool mount assembly include three translation axes being Y-translation, along the outer rails by virtue of servo motor 27, X-translation along cross bars 48, 50, by virtue of servo motor 52, Z-translation of the vertical rails 54 relative to cradle 19, by virtue of stepper motor 25. There are also two rotational axes of motion being rotation about the spindle of pan servo motor 64 and rotation about the spindle of roll servo motor 64. The tool mount of gantry 23 is similarly a 5-degree arrangement in the same fashion as that of gantry 13. However, gantry 21 includes an additional tilt servo motor coupled, at right angles, between pan servo motor 64 and roll servo motor 68 in order to provide a tool mount with six degrees of motion.

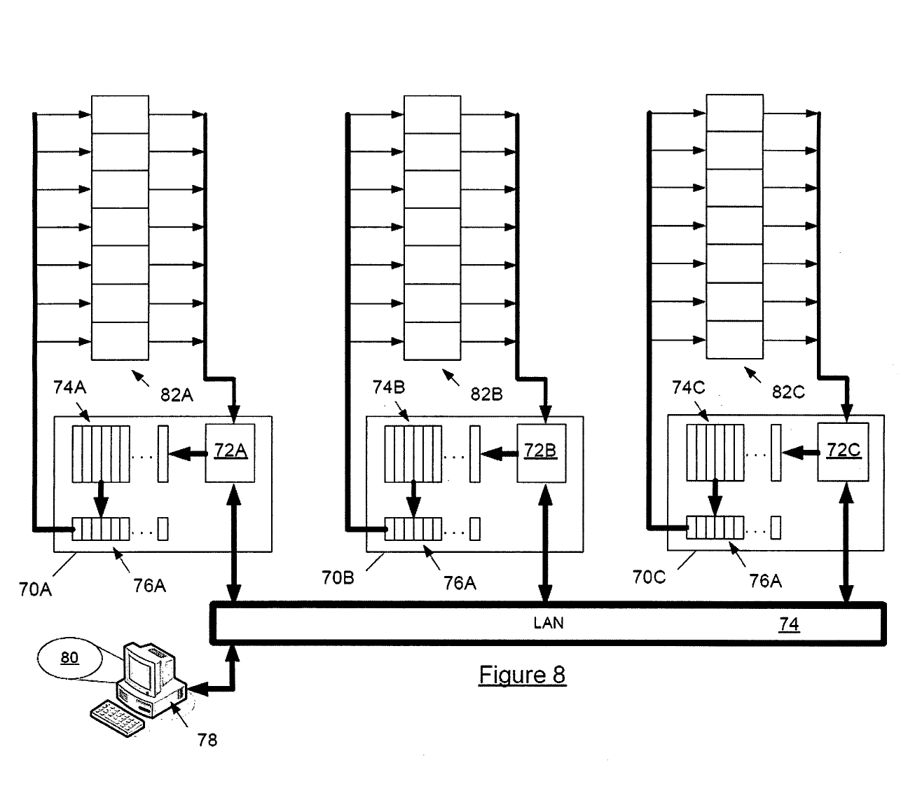

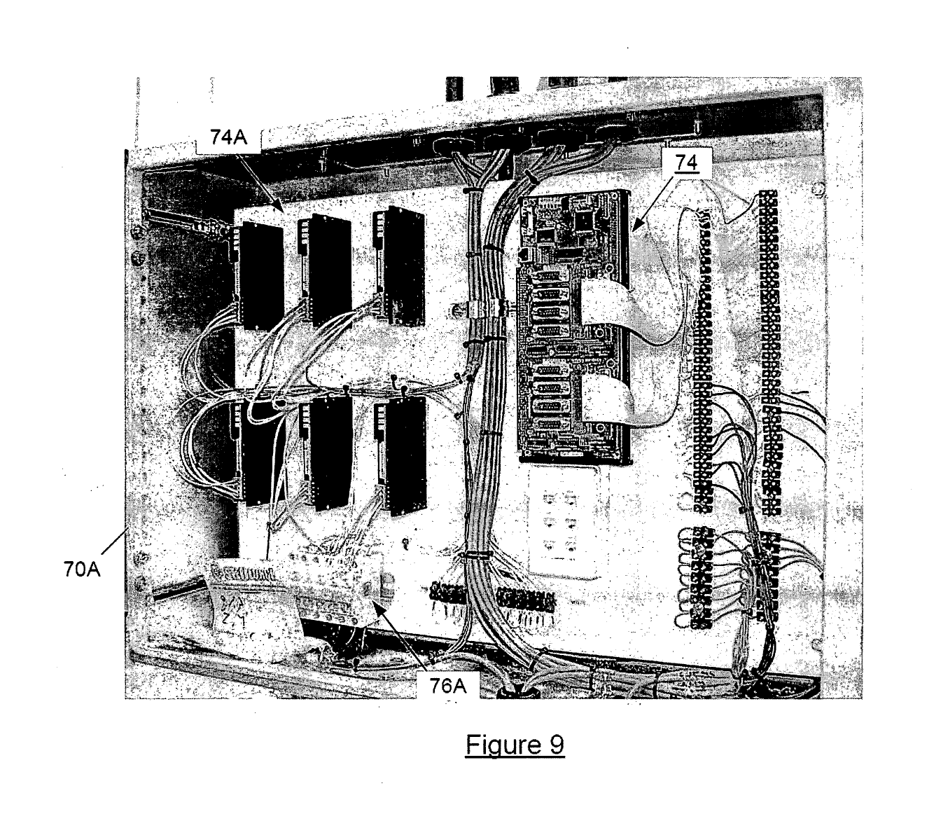

A block diagram of the controller system is shown in FIG. 8. The controller system includes three controller cabinets, 70A, 70B, 70C, corresponding to each Gantry. FIG. 9 shows the interior of cabinet 70A.

Each controller cabinet contains a GaM controller board 72A, 72B, 72C, that is coupled to a corresponding PWM servo amplifier array 74A, 74B, 74C that in turn drives an array of servo motors 82A, 82B, 82C associated with the gantries, vises and tool mounts. Circuit breaker arrays 76A, 76B, 76C protect the servo amplifiers and the servo motors from over-current surges.

The controller boards 72 each receive encoder data from the servo motors that they control. Each controller board is separately addressable on Ethernet network 74 and communicates with master PC 78. The master PC 78 executes a program 80 that includes instructions to process steel fabrication shop drawings, extract relevant data, prompt for user input and convert the extract drawing data and user inputs into controller board commands addressed to the appropriate controller boards.

The program 80 is stored on secondary storage of the PC 78, such as a magnetic or optical disk.

In response to the commands from the PC 74, the controller boards operate the servo-motors to carry out the fabrication operations. They also pre-process and relay encoder data from the servo motor encoders back to the PC 78.

The controller boards 72A, 72B, 7C comprise three Galil control boards. These are Ethernet addressable boards that can each control systems with up to eight motion axes. The Ethernet motion controllers are designed for extremely cost-sensitive and space-sensitive applications. The controllers are designed to eliminate the wiring and any connectivity issues between the controller and drives. Plug-in amplifiers are available for driving stepper, brush and brushless servo motors up to 500 Watts. Alternatively the boards can be connected to external drives of any power range.

Galil controllers are available from Galil Motion Control, 270 Technology Way, Rocklin, Calif. 95765, USA.

In use, the centre balanced vises 9 and 6 grip the beam 31 with jaws 11 and, by operation of their servo motors, e.g. servo motor 30A and 30B of vise 9 rotate arcuate cradle 18, thereby rotating the beam about its long axis. As a result the tool mounts, e.g. tool mount 62 of gantry 13 are able to access all sides of the beam. Furthermore, since the tool mounts operate with a number of degrees of freedom, the tools that are mounted to them are able to operate at virtually any angle on any side of the beam.

As an example of an embodiment of a method of operating the apparatus, suppose that it is desired to weld a component, such as a cleat to the beam at a predetermined position. Cleats are stored in a predetermined storage area, for example a cassette, mounted on or nearby the apparatus.

After the beam has been located in the opposing vises it is rotated so that the location on the beam for the cleat to be attached is available to the welding tool head. A laser measuring tool head then checks that the beam is correctly positioned and that the cleat is correctly orientated in the cassette. This last step may involve checking that asymmetrical slots, other apertures, edges or markings of the cleat are the correct way up.

Provided that the cleat is correctly orientated an electromagnetic head then operates to hold the cleat and move it to the correct position on the beam for welding. A welding head then operates in concert with the electromagnetic head to weld the cleat to the beam. It will be realised that in this method the translational assemblies in the form of the gantries, to which the electromagnetic head, laser head and welding head are mounted, all move up and down the length of the beam in order that the tool heads can carry out the various operations. During execution of this method the servo motors on the tool head mount, and the various gantry and vice servo motors, are all operated and monitored, i.e. controlled by the control system illustrated in FIG. 8.

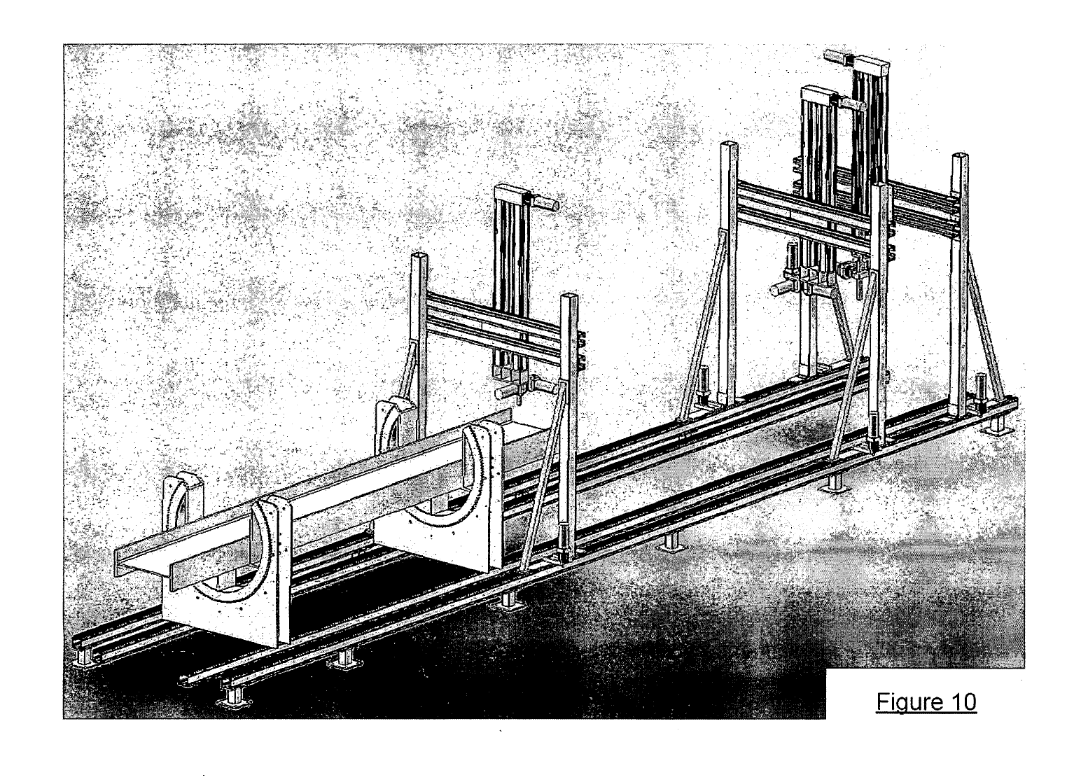

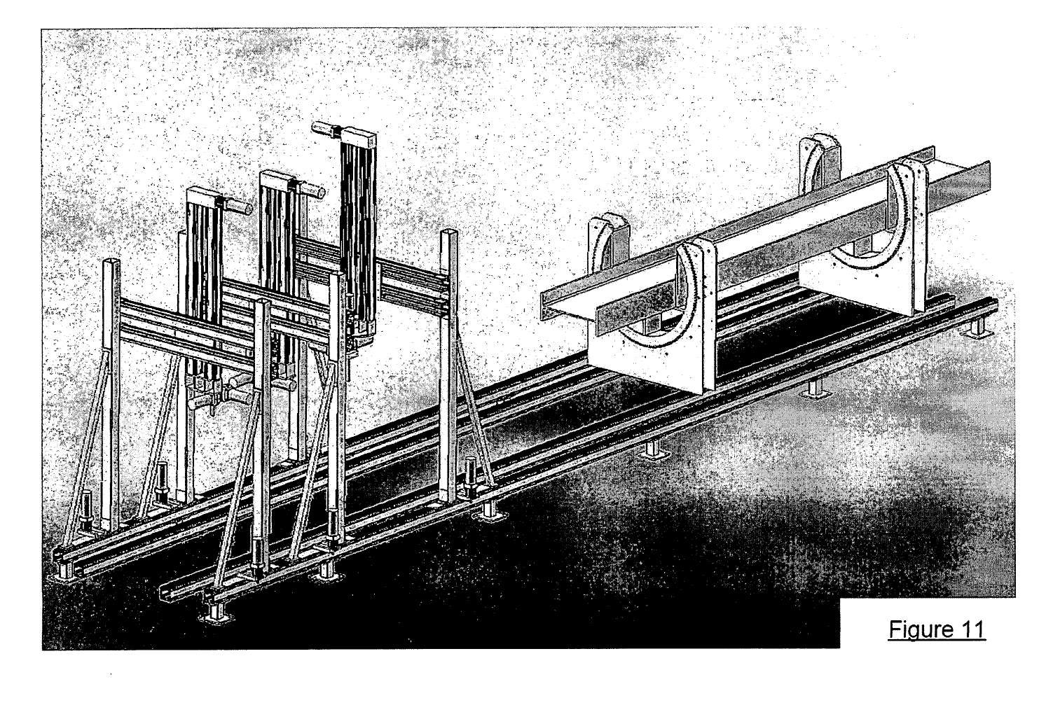

FIGS. 10 and 11 show the fabrication machine 1 during various stages of working with the gantries and and vises having having been slid along rails 2 and 4 to various positions.

The machine may be further operated to:
i) cut the work piece to length, with square, angled, simple curved or complex curved cuts.
ii) cut holes on any face of the work piece.
iii) apply an identification mark to the work piece.
iv) hold cleat in place ready for welding.
v) tack weld a cleat.
vi) fully weld a cleat.
vii) spray paint the finished item with a spray paint head.

During its operation, relative motion between the tool mounts and the workpiece, e.g. the beam, may be achieved by either keeping the vises stationary and moving the tool or moving both the work and the tool simultaneously. The controller system can be programmed to process multiple small parts from the one length of material, with the work area remaining stationary and the material being fed into the work area after the last part has been processed.

The invention has been explained with reference to a particular embodiment wherein the translation assembly for the tool head mounts comprises a number of gantries that run on rails. However, other translation assemblies are possible. For example, in a further embodiment the translation assembly may include wheels or runners that slide along guides mounted to a ceiling above the vises.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A beam working apparatus, including:
a vise assembly for holding and rotating a beam about a long axis thereof;
at least one translation assembly for motion along the beam; and
at least one tool head mount fast with said translation assembly for a tool for working upon the beam.

2. The beam working apparatus according to claim 1, wherein the vise assembly includes a pair of opposed vises arranged to cooperatively hold and rotate the beam.

3. The beam working apparatus according to claim 2, including at least one motor to draw the vises together and apart.

4. The beam working apparatus according to claim 2, wherein the vises include respective rotatable cradles to support the beam.

5. The beam working apparatus according to claim 4, wherein the vises include at least one motor to rotate the cradles.

6. The beam working apparatus according to claim 3, wherein the at least one motor to draw the vises together and apart is coupled to a rack and pinion arrangement.

7. The beam working apparatus according to claim 6, wherein the vises run on wheels and wherein the rack and pinion arrangement includes a first rail, fitted with the rack, and a pinion for meshing with the rack, the pinion being fast with a spindle of the at least one motor, the motor being fast with one of the vises.

8. The beam working apparatus according to any one of the claim 7, wherein the translation assembly comprises at least one gantry.

9. The beam working apparatus according to claim 8, wherein the apparatus includes a gantry motor to move the gantry relative to the vise assembly.

10. The beam working apparatus according to claim 8, wherein the at least one gantry rides along at least a second rail.

11. The beam working apparatus according to claim 10, wherein the at least one gantry rides along a first pair of rails and the vises ride along a second pair of rails.

12. The beam working apparatus according to claim 11, wherein the first pair of rails is located outside the second pair of rails.

13. The beam working apparatus according to any one of claim claim 8, wherein the at least one gantry comprises three gantries and the at least one tool head mount comprises three corresponding tool head mounts coupled thereto.

14. The beam working apparatus according to claim 13, wherein at least one of a welding tool, a laser position detector, a cutting tool, and/or an electromagnet for selectively holding components to be welded to the beam is mounted to one of the tool head mounts.

15. (canceled)

16. (canceled)

17. (canceled)

18. The beam working apparatus according to claim 14 including a holder at a predetermined position for storing the components.

19. The beam working apparatus according to claim 1, wherein the tool head mount comprises pan and tilt motors.

20. The beam working apparatus according to claim 16, wherein the tool head mount further comprises a roll motor.

21. The beam working apparatus according to any one of the preceding claims claim 1, including a computerized control system arranged to read electronic files containing information for working of the steel beam by the vise assembly, the translation assembly; and at least one tool head mount.

22. The beam working apparatus according to claim 18, wherein the computerized control system includes one or more controller boards arranged to interface between a computer for reading the electronic files and motors of the apparatus.

23. The beam working apparatus according to claim 19, wherein the controllers are responsive to position encoders of the motors.

24. A method of working a beam comprising the steps of:
rotating the beam along its long axis through a desired angle for access by a tool head;
checking the position of the beam with a laser measuring device;
moving the tool head to a predetermined position adjacent the beam; and
operating the tool head upon the beam;
wherein each step of the method is controlled by an electronic control system.

25. The method according to claim 21, including a step of relocating a component for attachment to the beam from a storage position to the predetermined position by gripping the component with an electromagnet, wherein the method includes checking the component for correct orientation with the laser measuring device.

26. (canceled)

27. The method according to claim 22, further including operating the electromagnet and the welding head in concert to weld the component to the beam.

28. The method according to claim 23, wherein the tool head is moved along the beam by a translation assembly to the predetermined position.
